(19) United States
(12) Patent Application Publication
(10) Pub. No.: US 2007/0068053 A1
(43) Pub. Date: Mar. 29, 2007

(54) Method and system for creation of fireworks and laser show by generating effects of laser-material interaction

(76) Inventor: Igor Troitski, Henderson, NV (US)

Correspondence Address: IGOR TROITSKI, 853 ARROWHEAD TRAIL, HENDERSON, NV, 89015, US

(21) Appl. No.: 11/234,813

(22) Filed: Sep. 26, 2005

(51) Int. Cl. G09F 13/00

(52) U.S. Cl. 40/442; 362/259; 362/806

(57) ABSTRACT

The invention discloses a method and system for creation of fireworks and laser show by generating effects of laser-material interaction and in particular by generating laser-induced breakdowns. The fireworks have the following particulars: each spark can be created at the pre-set position; the time existing and brightness of each spark can be controlled; each spark can have desirable speed and the trajectory movement; the laser-induced fireworks can reproduce any desirable spark arrangement, in particular 2D, 3D images or an abstract pictures. A method for creation of a laser show is founded on the use of a combination of the effects accompanying the laser-induced breakdowns and other laser-material interaction phenomenon. A method discloses the laser show which uses of the inflated balloons having special shapes and characteristics needed for the production of the desirable visual effects generated by laser radiation. A system for creation of fireworks and laser show is also disclosed.

### FIELD OF THE INVENTION

The present invention relates to laser systems which use effects of laser-induced breakdown for creation of fireworks and laser show.

### BACKGROUND OF THE INVENTION

Although firework technology has large history of its development, new methods and firework devices for specific visual effects are creating permanently.

U.S. Pat. No. 4,025,289 to Duncan, et al. discloses a fireworks device including suspended body of flame dripping low molecular weight polyethylene material which produces a shower of flaming beads when ignited.

U.S. Pat. No. 4,566,388 to Loyd, Jr. discloses a method of constructing fireworks wherein a relatively small conventional Class C firework is assembled within an enlarged supplemental housing and wherein the relatively small Class C firework is positively retained in spaced relationship from the walls of the supplemental housing along its length and a safety fuse extends from said smaller firework and outwardly of said supplemental container.

U.S. Pat. No. 4,719,857 to Spring discloses a pyrotechnic device which comprises a projectile, a ground mounted device or a floating device whose casing contains a charge of particulate material, for example a combustible silicon-containing material in particular mixed with titanium or other suitable combustible metal-containing material and gunpowder such that, following ignition, infra-red emitting particles are emitted for forming an infra-red radiating screen.

U.S. Pat. No. 5,525,166 to Cook discloses a pyrotechnic composition, particularly for fireworks, which contains an organic compound having at least one aromatic group as a binder. The compound preferably has a weight ratio of carbon:hydrogen of at least 10:1 and is substantially free of groups of the formulae COOH or COO.sup.−M.sup.+, wherein M.sup.+is the equivalent of a metal ion.

U.S. Pat. No. 5,627,338 to Poor, et al. discloses a system and method for launching projectiles, such as fireworks projectiles, which explode in the air into a pyrotechnic display. The projectile includes a shell constructed from a binding agent and an explosive additive which explodes the shell into small particles. The explosive additive, which may be nitrocellulose, causes the exploded particles to be rapidly burned and consumed to form lightweight, inert flakes that fall harmlessly to the ground. The projectile is aimed and launched by a launcher to rapidly expel the projectile from a launching tube. Once in the air at a predetermined location in the sky, a fuse inside the projectile operates to detonate the projectile into its intended pyrotechnic display. The fuse is extremely accurate and enables detonation of the projectile at precise altitudes. An electronic control system controls launching and detonation of the projectiles in a precise and repeatable manner. The external geometry of the projectile also is configured so that the projectile tumbles when launched and follows a more predictable, repeatable and accurate path in flight.

U.S. Pat. No. 6,582,115 to Huang discloses structure of firework light, wherein, a base is provided therein with an electric conductor and an automatic reeling device to lower the gravity of the firework light, and a post is provided to connect a hollow ball thereon, a lot of transparent radial rods are conveniently connected with the ball. An IC controller is provided in the hollow ball to separately control a flashlight, so that the IC controller makes the lamp strings in the radial rods flash sequentially after the flashlight flashes.

U.S. Pat. No. 6,840,177 to Hatteland discloses a fireworks device, including a number of light effect devices as a replacement for traditional pyrotechnic stars. Each light effect device includes electrical/electronic light sources, preferably high-intensity light-emitting diodes, an energy-storage device and a control device. The light effect device for use in such a fireworks device can be used together with a fireworks system, a fireworks rocket and a ground firework in which the firework device is included.

The patents mentioned above illustrate the general problems which are decided in modem pyrotechnic technology. The first group of these problems is closely related with creating and using new pyrotechnical materials, the second group is connected with creation of the control systems which control launching and detonation of the projectiles in a precise and repeatable manner, the third group is directed to creation of light effect devices which can replace traditional pyrotechnic stars. The present invention is related to the third group and based on the using of the effects accompanying the laser-induced breakdowns.

Today, laser-induced breakdown effect is widely used for creation of laser-induced images (Troitski, Laser-Induced Image Technology; Yesterday, Today and Tomorrow; SPIE Vol. 5664, 2005, pages 293-301). The principals of the laser-induced image technology can be basement for creation of methods and systems for production of fireworks and laser show by generating laser-induced breakdowns in air or inside special gas medium containing light parts.

U.S. Pat. No. 6,087,617 to Troitski et al. discloses a computer graphic system for producing an image inside optically transparent material. An image reproducible inside optically transparent material by the system is defined by potential etch points, in which the breakdowns required to create the image in the selected optically transparent material are possible. The potential etch points are generated based on the characteristics of the selected optically transparent material. If the number of the potential etch points exceeds a predetermined number, the system carries out an optimization routine that allows the number of the generated etch points to be reduced based on their size. To prevent the distortion of the reproduced image due to the refraction of the optically transparent material, the coordinates of the generated etch points are adjusted to correct their positions along a selected laser beam direction.

U.S. Pat. No. 6,333,486 to Troitski discloses a method for production of etch points inside transparent material, which have the same size but different brightness. Laser-induced damages produced by this method provide the reproduction of image gradation without changing of their spatial resolution.

U.S. Pat. No. 6,399,914 to Troitski discloses a method for producing laser-induced images inside the special transparent material containing special kinds of impurities, which decrease the damage threshold of the material that provides creation of small and without star structure laser-induced damages.

U.S. Pat. No. 6,417,485 to Troitski discloses a method and laser system for producing laser-induced damages inside transparent materials by controlling breakdown process development. At the beginning an applied laser radiation level just exceeds an energy threshold for creating a plasma condition inside the transparent material, and thereafter the energy level of the applied laser radiation is just maintain the plasma condition and is applied before the plasma condition extinguished, but after a shock wave associated therewith has passeed.

U.S. Pat. No. 6,426,480 to Troitski discloses a method and system for producing single layer laser-induced damage portrait inside transparent material which are based on generation of small smoothed etch points of determined sizes and on control of their brightness without variation of their determined sizes.

U.S. Pat. No. 6,490,299 to Raevski et al. discloses method and laser system producing high quality laser-induced images inside transparent materials by using specific laser radiation generated by serial combination of both generation regimes: a Q switched mode and a free-running mode.

U.S. Pat. No. 6,509,548 to Troitski discloses a method and apparatus for producing high-resolution laser-induced damage images inside transparent materials by small etch points. The method is based on generation of the initial electron density in the relatively large volume, creation of the breakdown at a small part of the said volume and control of the energy amount enclosed inside the plasma.

U.S. Pat. No. 6,605,797 to Troitski discloses laser-computer graphics systems for producing images such as portraits and 3D sculptures formed from laser light created etch points inside an optically transparent material. The produced image has a high resolution like a computer graphic image from which it is derived, little fluctuation in gray shades, and has no dissemble point structure.

U.S. Pat. No. 6,630,644 to Troitski et al. discloses a method for creating arrangement of damages for producing 3D laser-induced damage portraits with the space resolution, which is equal to the appropriate computer 3D model.

U.S. Pat. No. 6,664,501 to Troitski discloses a method for creating laser-induced color images within three-dimensional transparent material.

U.S. Pat. No. 6,670,576 to Troitski et al. discloses a method for producing laser-induced images inside transparent materials containing laser-induced color centers and laser-induced damages.

U.S. Pat. No. 6,720,521 to Troitski discloses a method for generating an area of laser-induced damage inside a transparent material by controlling a special structure of a laser radiation.

U.S. Pat. No. 6,720,523 to Troitski discloses a method for production of laser induced images inside transparent material, when complete image information is lacking before production and is supplemented only during production.

U.S. Pat. No. 6,727,460 to Troitski discloses a system for high-speed production of high quality laser-induced damage images inside transparent materials. The system produces the said images by the combination of an electro-optical deflector and means for moving the article or focusing optical system.

U.S. Pat. No. 6,734,389 to Troitski discloses an apparatus for producing high quality laser-induced images inside optically transparent material by controlling breakdown process development and space structure of laser radiation.

U.S. Pat. No. 6,768,080 to Troitski discloses a method for production of laser-induced images which are looked like iridescent images laying out white light incident upon them. These images are created by generation of laser-induced damages of special space form.

U.S. Pat. No. 6,768,081 to Troitski discloses a method and apparatus for producing high quality laser-induced images inside optically transparent material by using material processing made before and after image creation.

The patents mentioned above disclose methods and systems using one effect of laser-induced breakdown, namely, creation of laser-induced damages. However, laser-induced breakdown produces and another effect, which is generation of a burst of bright light. The purpose of the present invention is to use both these effects for creation of methods and systems producing fireworks and specific visual effects.

### SUMMARY OF THE INVENTION

The purpose of the present invention is the disclosure of a method and a laser system for production of fireworks and a laser show by generation of the laser-induced breakdowns.

The invention discloses a method for creation of fireworks by generation and control of the laser-induced breakdowns, comprising: generation of laser radiation for which a surrounding gaseous medium is transparent; direction of the laser beams at the predetermined areas of the surrounding gaseous medium; generation of laser-induced breakdowns inside the said pre-set areas by creation of laser power which increases breakdown threshold of the surroundings; control of the laser beams directions; their energy and repetition of laser pulses for generating and maintaining breakdowns of needed properties during production of the fireworks.

Fireworks created by the laser-induced sparks have the following particulars: each spark can be created at the pre-set position; the brightness of each spark can be controlled; the time existing of each spark can be controlled; each spark can have desirable speed and the trajectory movement; the laser-induced fireworks can reproduce any desirable spark arrangement, in particular 2D, 3D images or an abstract pictures.

One or more embodiments of the invention comprise a method for creation of a laser show, comprising: lightweight inflated balloons which are launched at the show field and the surfaces of which have the characteristics corresponding to the generation of the desirable laser-material interaction effects; generation and formation of visible and invisible laser beams for which a surrounding gaseous medium is transparent; direction of the generated laser beams at the predetermined areas of the said scene areas; control of the laser beam energy for generation of desirable interaction of the laser radiation with the elements of the scene area for the purpose of generating the specific visual effects.

Such show reproduces a colored performance where actors are the inflated balloons.

Another embodiment of the invention comprises a system for creation of fireworks and laser show, comprising: lasers for generation of radiation capable to illuminate predetermined objects and to interact with the elements of the scene for creation of desirable visual effects; system for formation and direction of the laser beams at the desirable objects and predetermined areas; system for controlling laser parameters including laser radiation and direction of separated laser beams; system for controlling show field effects including determination and control of predetermined areas and objects inside the show field.

### DESCRIPTION OF THE DRAWINGS

FIG. 1 illustrates the creation of the fireworks by generation of the air laser-induced breakdown by focusing laser radiation. The letters a, b, c, d, e, f denote the laser-induced sparks, which have been generated before the spark “g” by successive focusing laser beams.

FIG. 2 illustrates the creation of fireworks by generation of air laser-induced breakdown by intersection of two beams created by two mirrors J and K accordingly. The letters a, b, c, d, e, f denote the laser-induced sparks, which have been generated before the spark g by the intersection of corresponding laser beams.

FIG. 3 illustrates the principal particulars of the show by an example of the star wars. Extraterrestrial complexes A and B are lightweight inflated balloons which are lunched at the show field. MA and MB are lightweight metallized film mirrors focusing the laser radiation generated by a land-based laser and control beam system; “b” is a laser-induced spark generated by beam 1 focused by mirror MB; “a” is a laser-induced spark generated by beam 2 focused by mirror MA.

FIG. 4 illustrates a method for the creation of an illusion of the firing from one spaceship to another by using beams of a land-based laser without special focusing elements placed on the extraterrestrial complexes. Sparks corresponding to shooting of spaceship A are generated from spaceship A to spaceship B, so that the spark “a” is the first one, spark “b” is the second one, spark “c” is the third one and spark “d” is the last one. The shoot of spaceship B is imitated counter: spark “e” is the first one; spark “f” is the second one.

FIG. 5 shows the fragment of a star war show, when many small spaceships appear after destruction of the extraterrestrial complex A and the extraterrestrial complex B tries to defeat these spaceships.

FIG. 6 illustrates in block-diagram form a system for creation of the fireworks and a laser show. Arrows show the direction of the information by which the subsystems communicate during a laser show.

### DETAILED DESCRIPTION OF THE INVENTION

The invention comprises a method and a laser system for creation of fireworks and a laser show by generation of desirable visual effects arising from interaction of laser radiation with material of the show field parts and surroundings.

The very interesting and promising visual effects arise during laser-induced breakdowns generated inside air, liquids and transparent materials. Therefore general concepts of the present invention are based on the generation and control of the physical processes accompanying the laser-induced breakdown together with other laser-material interaction effects. It is known that if medium is transparent for used laser radiation, the radiation passes through the medium without interaction with its material. But when the power density increases a threshold, the value of which is determined by the material of the medium, a laser-induced breakdown is created. As a result of a laser-induced breakdown there are two visual effects: the first is generation of a burst of bright light (laser-induced spark), and the second is creation of a laser-induced damage. Controlling the laser-induced breakdown process development, it possible to control the damage parameters and light burst parameters. The principals of the control of the breakdown process development for the production of controlled laser-induced damages inside transparent materials were disclosed in U.S. Pat. No. 6,417,485 to Troitski. In this invention these principals are developed for the creation of controlled laser-induced sparks which can be used in methods and systems producing fireworks and laser show.

The process of laser-induced breakdown development inside solid transparent material has several stages:
1) Creation of an initial low-density free electron concentration.
2) Buildup of this electron concentration until a density of 10.sup.18 to 10.sup.19 cm.sup.−3 is reached.
3) Absorption of the remainder of the laser pulse by the resulting plasma.
4) An increase in temperature to a value of several thousands of degrees.
5) The generation of an initial thermally-induced sound wave which is the response of the medium following the thermal expansion of the central region during the laser heating pulse, which sound wave propagates outward.
6) The expansion of created liquid at a rate much slower than the speed of sound.
7) The generation of a pressure-induced sound wave as the liquid forms higher pressure with gradients of the order of several GPa/.mu.m.
8) The formation of cracks at the liquid/solid interface (velocities in the range of 1 to 2 km/s).

From point of view of the creation of the fireworks, the most interest is the process of the spark arise which is determined by the first six stages. Just these first six stages are general for breakdown development inside such transparent material as gases and liquids. These stages are very important for the control of the spark parameters needed for the fireworks.

Thereby, a laser-induced spark is a result of radiation of hot plasma generated during a breakdown process. The spark exists while the hot plasma exists. Time period of hot plasma existing (and consequently, time existing of the spark) is proportional to the pulse duration and the total laser energy. The brightness of a spark is proportional to the total energy of the laser radiation generating the laser-induced breakdown.

One or more embodiments of the present invention are a method for creation of fireworks by generation and control of laser-induced breakdowns, comprising:
determination of laser radiation parameters needed for creation of laser-induced sparks desirable for fireworks;
formation of an arrangements of laser-induced sparks including their space configuration at the show field;
generation of laser radiation for which a surrounding gaseous medium is transparent and which has the predetermined parameters;
direction of the laser beams at the predetermined areas of the laser show field corresponding to the said laser-induced spark arrangement;
generation of laser-induced breakdowns inside the said pre-set areas by creation of the laser power which increases breakdown threshold of the surroundings;
control of the laser beams directions, their energy and the repetition of the laser pulses for generating and maintaining breakdowns of needed properties during production of the fireworks.

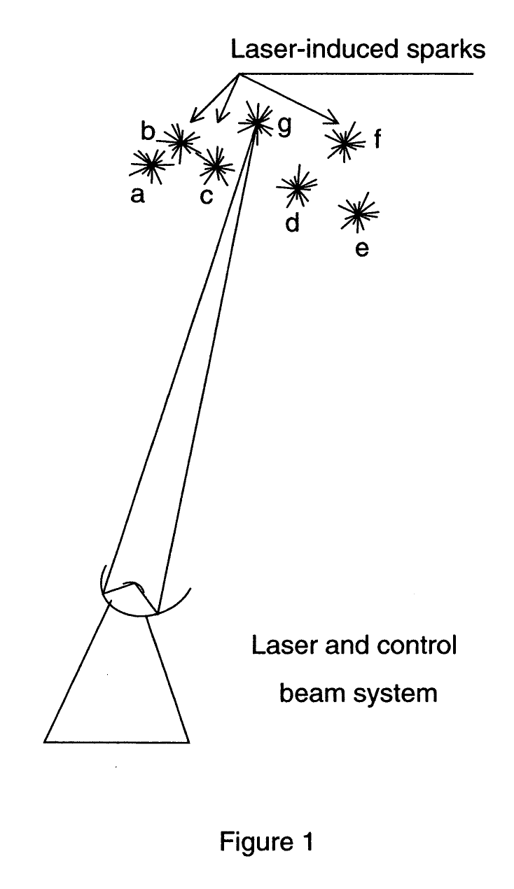

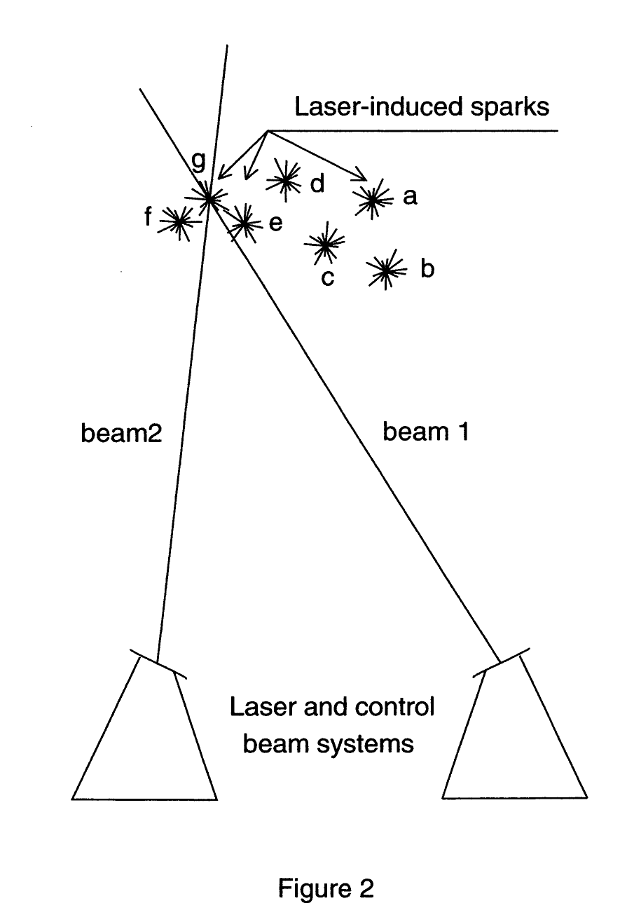

Creation of an area at which the laser power increases the breakdown threshold can be provided by focusing laser radiation at the pre-set area or by the intersection of several beams at the area. FIG. 1 shows generation of air laser-induced breakdown by focusing laser radiation. FIG. 2 shows generation of air laser-induced breakdown at the predetermined area by the intersection of two beams. In the case, when the areas contain only air, the laser power should increase air breakdown threshold.

Another embodiment of the invention is a method for creation of an area, where laser energy increases the breakdown threshold, is founded on the self-focusing of the used laser radiation. Control of a position and a shape of self-focusing area is provided by the control of space structure of the laser radiation, its energy and pulse duration.

One or more embodiments of the present invention are a method for creation of fireworks by generation of the laser-induced breakdowns inside areas which contain both air (perhaps, with gas inclusions) and a gathering of lightweight parts or pieces (solid or liquid). In this case, the laser power should increase breakdown threshold corresponding to the material of the said lightweight parts or pieces. If breakdown is produced on the surface of the parts then breakdown threshold drops and therefore, needed laser power is decreased. But it is more important that this method provides the production of new lighting effects. So using lightweight parts of special forms (as inflatable transparent prism), it is possible to transform wideband light of breakdown spark into rainbow light. Using colored lightweight parts, audience can see the light of the breakdown sparks and the colored spark light diffusing by these colored parts. Using special gas inclusions or small liquid drops, it is also possible to generate colored breakdown sparks.

The areas containing air (perhaps, with gas inclusions) and a gathering of lightweight parts or pieces (solid or liquid) can be created by many different ways. One way is launching inflated balloons containing desirable materials. When the balloons are at the predetermined areas, the laser beams destroy the balloons and gas inclusions and a gathering of lightweight parts contained inside the balloons fill up the areas. It is very important to notice that if launching inflated balloons have transparent covering then it is not necessary to destroy the balloons because it is possible to create desirable visual effects inside the balloons directly.

One or more embodiments of the present invention are a method for creation of fireworks inside inflated balloons having transparent cover. Being transparent cover for the used laser radiation, the cover of the balloon can have complicated spectral characteristics, using of which gives a chance to create special visual effects. The balloons can contain the special gases with special inclusions that also permits create colored fireworks.

Destruction of balloons can be produced by using different effects accompanying laser-material interaction (for example, heating, melting, and laser-induced breakdown on the surface of the balloons).

Usually firework is the arrangement of sparks which are scattered in a random way. Creating the sparks by generation of laser breakdowns, it is possible to produce firework by both in a random way and in a control way.

In one aspect, the invention provides a method for creation of fireworks, the sparks of which are located so as it is desirable, creating any show image. In this case an image (notional or abstract image, an inscription, portraits and so on) is represented as an arrangement of sparks and laser beams are directed at the space points of the show field corresponding to the arrangement of sparks.

It is important to underline, that the firework images can be 2D or 3D pictures. The space resolution of the picture is determined by the number of firework sparks and the image gradation is reproduced by the brightness modulation of separated sparks.

Another embodiment of the invention is a method for creation of the fireworks, sparks of which exist during controllable period of time. This effect is provided by repetition of laser pulses at the areas at which sparks should be maintained. The repetition frequency is determined so that the period of time between neighboring pulses is shorter than the vision persistence.

One or more embodiments of the present invention are a method for creation of fireworks, the sparks of which are moved in the desirable direction with desirable speed. If laser-induced spark is created by focusing laser radiation at the pre-set area then its direction and speed are determined by direction and speed movement of the focal area. If laser-induced sparks are generated in the intersection of several laser beams then direction of the sparks and their speeds are controlled by the direction and the speed movement of the beams.

Another embodiment of the invention is a method for the creation of fireworks, the sparks of which have desirable shapes. This method is based on the fact that spark shape depends on the space form of the breakdown area. The form is determined by the shape of the focal area, if breakdown is generated by focusing laser radiation, or by the shape of an intersection area, if breakdown area generated by intersection of several beams.

The laser radiation used for the fireworks can be visible or invisible with naked eye. In case of using invisible laser radiation, it is possible to use the visible laser radiation for visualization of the defined point around of which the breakdowns of the fireworks are generated by invisible laser radiation.

One or more embodiments of the present invention are a method for creation of fireworks wherein several sparks are created by one laser pulse. This is provided by forming special space structure of the laser radiation so that the radiation has speckle structure at the pre-set area. As a result of the speckle structure, the breakdown sparks arise only at the places corresponding to the speckles.

Another embodiment of the present invention is a method for control of firework parameters by the control of laser radiation characteristics. In particular, it is possible to select pulse duration, pulse energy and space structure of laser radiation so that areas, where laser radiation increases the breakdown threshold, are formed by self focusing.

Consequently, a method for creation of the fireworks by generation and control of laser-induced breakdowns comprises the following steps:

Step 1. Formation of the firework field, which can be air area, air area and a gathering of lightweight parts or an area inside inflated balloon with transparent cover;

Step 2. Selection of the kind of the fireworks, which can be created by the random sparks, sparks moved along the desirable paths or an arrangement of sparks corresponding to the desirable pictures;

Step 3. Determination of the space positions of the laser-induced breakdowns creating the fireworks.

Step 4. Determination of laser radiation characteristics providing the creation of desirable laser-induced breakdowns and generation of the corresponding laser beams.

Step 5. Direction of the said laser beams at the predetermined areas of the firework field;

Step 6. Control of the laser beams directions, their energy and repetition of laser pulses for generating and maintaining breakdowns of the needed properties during production of fireworks.

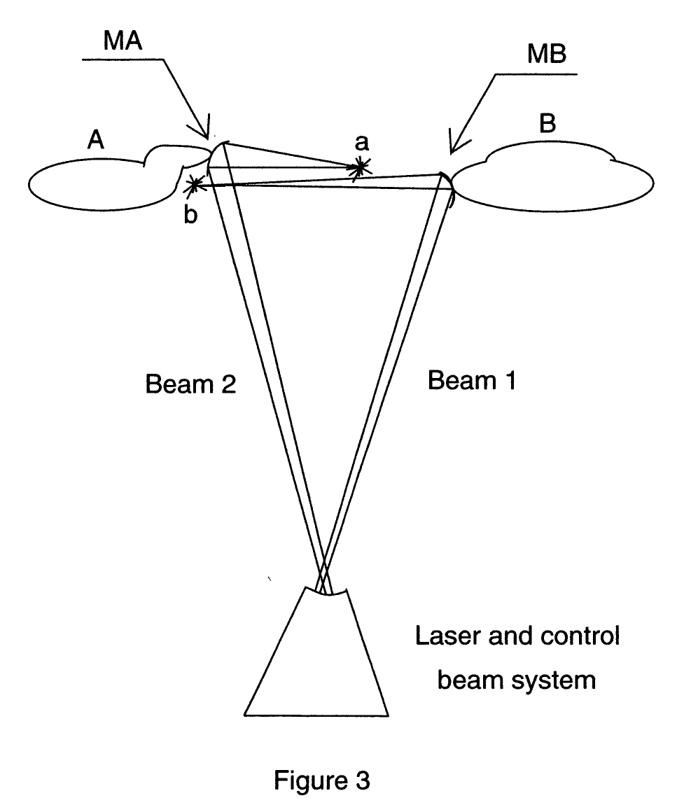

Fireworks are produced by using only laser-induced breakdowns. Combination of the breakdown phenomenon with other laser-material interaction effects provides the creation of specific laser show. FIG. 3 illustrates the principal particulars of the show by the example of the star wars. Extraterrestrial complexes are lightweight inflated balloons which are lunched at the show field. These spaceships can moved by wind or by any another way. These complexes can have their own lightweight lasers or special elements which reflect the laser beams directed by a land-based laser. These reflective elements can be placed inside the balloons, if the balloons have transparent cover, or can be created on the balloon surfaces. These reflective elements can also work like focusing optical elements, which are able to focus laser beams so that their energy at the focal areas increases the breakdown threshold. In this case a land-based laser generates beams which are directed on the reflective focusing elements of the spaceships, which generate laser-induced breakdowns at their focusing areas. The positions of the focusing areas are controlled by the directions of the laser-beams and reflective elements. The used laser radiation can be visible or invisible. Spectators see only breakdown sparks and do not see laser radiation if it is used corresponding wave-length or short pulse duration.

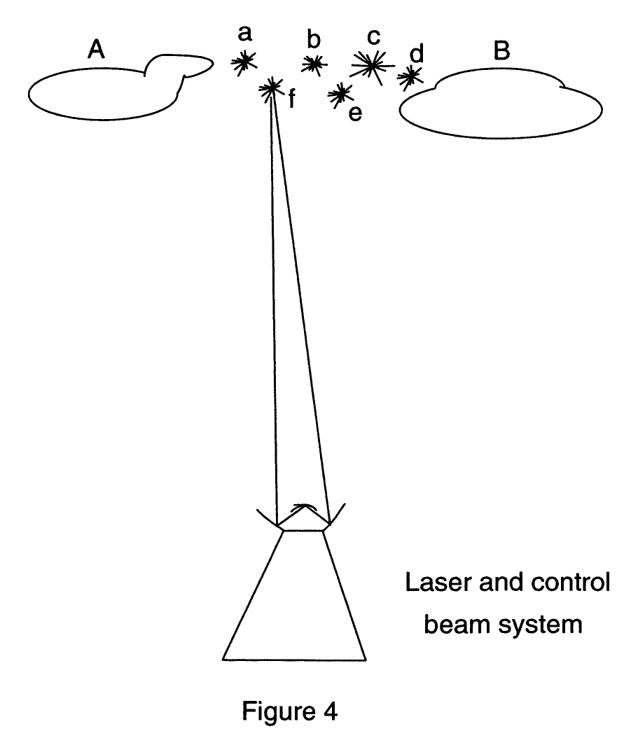

FIG. 4 illustrates another method for the creation of star wars show. In this case the fire from one spaceship to another is the special dynamic arrangement of the laser-induced breakdowns moving from one balloon to another. Such dynamic arrangement is created by the corresponding movement of the focal area of the beam generated by a land-based laser. Thus, a trace path of the fire from one balloon to another is an illusion of the fire between the spaceships, and in this case it is not necessary to place any special reflective elements on the balloons.

Creation of the desirable trace path of the fire demands the determination of the coordinates of the trace path. Source information for this determination can be space coordinates of the selected parts of the extraterrestrial complex. These coordinates can be measured by the standard ways.

It is possible that small lightweight lasers are also placed inside the inflated balloons in addition to a land-based laser for production of special visual effects during the laser show. These lasers can also works like the laser pointers for the selection of the needed objects.

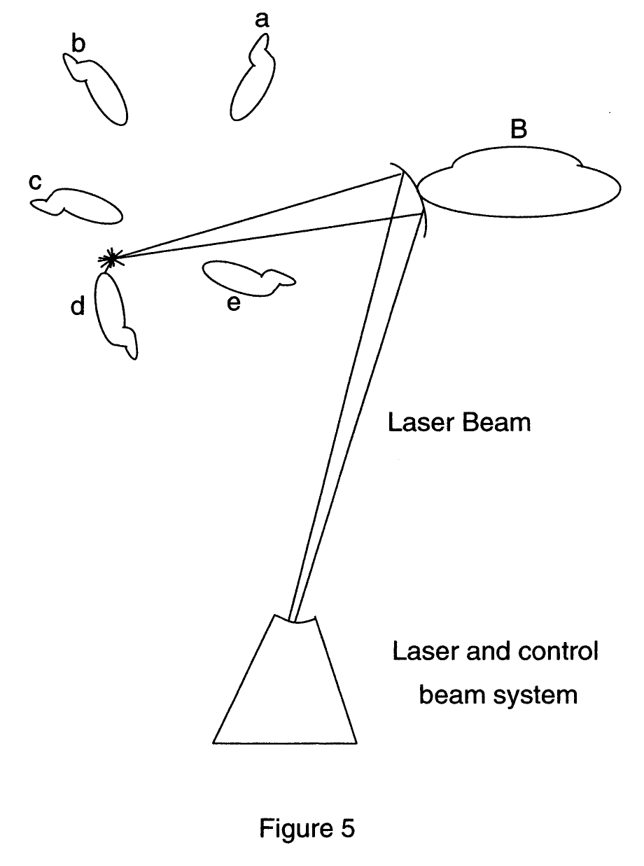

Each extraterrestrial complex can contain several small spaceships which are corresponding small inflated balloons. The internal gas pressure of the extraterrestrial complex is selected so that it is very easy to destroy the balloon by the laser-material interaction effects and so that the internal gas pressure is able to scatter the small inflated balloons. So after the one general extraterrestrial complex is fired the residuary general complex continues the fire with small spaceships of the beaten complex. FIG. 5 shows the fragment of a star war show, when the extraterrestrial complexes contain many small spaceships which appear after destruction of one of the general complexes.

The extraterrestrial complex or its small spaceships can contain lightweight parts which are scattered after destruction of the spaceships. The parts can be used for additional visual effects, for example, for generation of laser-induced fireworks at the area of broken balloon.

The surfaces of the balloons or arrangements of light parts (impurities, liquid drops) appeared after destruction of a balloon can be used as big screens for the projection of light pictures accompanying the laser show.

In one aspect the invention provides a method for creation of laser show inside lightweight inflated balloons having transparent covering. In this case, the interior of the general balloon is a show field and small inflated parts contained inside the balloon are subjects of laser-material interaction for the production of the desirable show effects.

One or more embodiments of the present invention are a method for creation of a laser show, comprising:
creation of the lightweight inflated balloons of the forms necessary for the show and the surfaces of which have the characteristics needed for the generation of the desirable laser-material interaction effects;
infilling the said balloons of the additional lightweight objects which can be used during laser show and launching the balloons inside the scene area of the show;
generation and formation of visible and invisible laser beams for which a surrounding gaseous medium is transparent;
generation of laser-induced breakdowns at the predetermined areas of the said scene areas;
control of the laser beam energy for generation of desirable interaction of the laser radiation with a surrounding gaseous medium and the elements of the scene area for the purpose of generating the specific visual effects.

A method for creation of a laser show comprises the following steps:

Step 1. Determination of characteristics of inflated balloons corresponding to the desirable laser-material interaction effects including the internal gas pressure, optical characteristics of the cover and the parts containing inside the balloons;

Step 2. Formation of the inflated balloons having desirable shapes and containing predetermined parts;

Step 3. Determination of the laser radiation parameters providing desirable effects as a result of the interaction of the laser radiation with a surrounding and the inflated balloons;

Step 4. Selection of a method for the laser-material interaction between the different balloons;

Step 5. Determination of a method for the control of the positions of different balloons;

One or more embodiments of the present invention are a system for creation of fireworks and laser show, comprising:
system for show information gathering;
system for determination of inflated balloon characteristics;
system for determination of parameters of laser radiation producing desirable laser-material interaction effects;
system for creation of inflated balloons;
system for launching inflated balloons at the show field;
system for measurement of the balloons positions;
system for generation of the laser radiation;
system for creation breakdown areas at the pre-set positions;
system for controlling laser radiation during laser show.

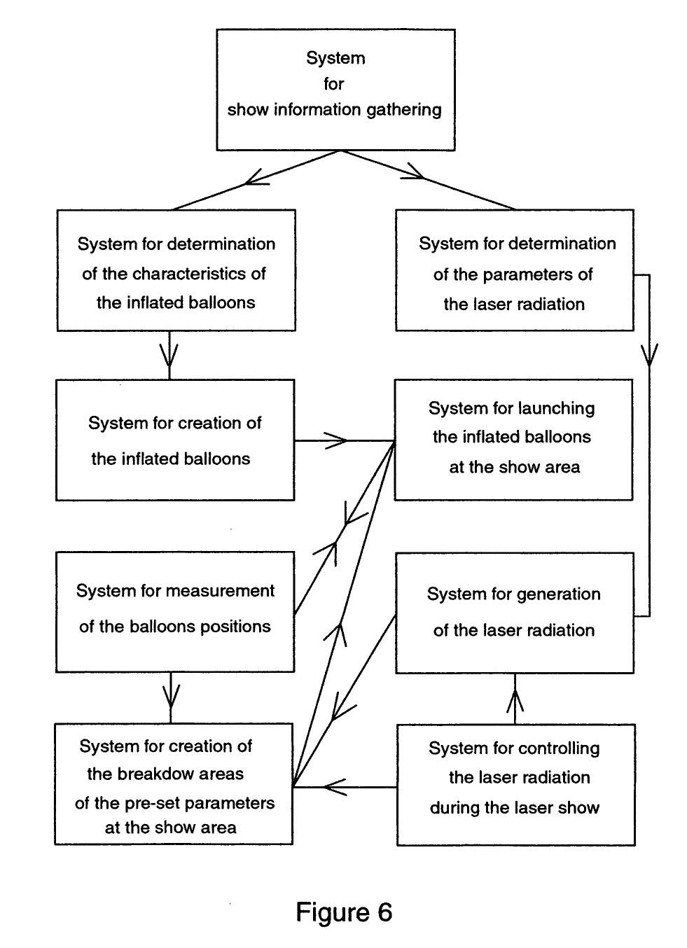

FIG. 6 illustrates in block-diagram form a system for creation of fireworks and laser show.

A system for show information gathering processes all information concerning the laser show and transfers the corresponding information to a system for determination of the inflated balloons characteristics and a system for determination of the parameters of the laser radiation.

A system for determination of the inflated balloons characteristics determines the parameters of balloon covering, balloon shapes, internal gas pressure; parts which are placed inside the balloons and on their surfaces and which are needed for production of the desirable show.

A system for determination of the parameters of laser radiation determines the laser energy, timing and spatial data of the radiation, and pulse repetition.

A system for creation of inflated balloons produces the lightweight balloons which have predetermined covers and contain needed parts.

A system for launching inflated balloons at the show field launches the inflated balloons at the show area and controls their displacement during the show;

A system for measurement of balloons positions measures coordinates of the balloons during the laser show;

A system for generation of laser radiation generates laser beams, which have pre-set parameters needed for the creation of the desirable effects;

A system for creation breakdown areas at the pre-set positions focuses the laser beams at the predetermined areas or intersects them at the pre-set areas;

A system for controlling laser radiation during controls positions of the breakdown areas, their displacement and brightness of firework sparks.

I claim:

1. A method for creation of fireworks by generation and control of laser-induced breakdowns, comprising:
determination of laser radiation parameters needed for creation of the laser-induced sparks desirable for fireworks;
formation of an arrangements of the laser-induced sparks including their space configuration at the show field;
generation of laser radiation for which a surrounding gaseous medium is transparent and which has the pre-set parameters needed for laser show;
direction of the laser beams at the predetermined areas of the laser show field corresponding to the said laser-induced spark arrangement;
generation of laser-induced breakdowns inside the pre-set areas by creation of the laser power which increases the breakdown threshold of the surroundings;
control of the direction of the laser beams, their energy and the repetition of the laser pulses for generating and maintaining the breakdowns of needed properties during the production of the fireworks.

2. A method in accordance with claim 1 wherein the desirable laser-induced sparks of fireworks are generated by controlling pulse energy, pulse duration, temporal and spatial characteristics of laser beam and repetition of the pulses directed at the same space area.

3. A method in accordance with claim 2 wherein the brightness of the said laser-induced sparks are controlled by the laser pulse energy, shape and sizes of areas where laser energy increases the breakdown threshold.

4. A method in accordance with claim 2 wherein the time duration of the said laser-induced sparks are controlled by the laser pulse energy, pulse duration and the number of pulses directed at the same areas.

5. A method in accordance with claim 2 wherein the spark speed and movement in the desirable trajectory is generated by the corresponding speed and trajectory movement of the laser beams.

6. A method in accordance with claim 2 wherein the one laser-induced breakdown gives birth to several separated sparks by generation of laser radiation created at the breakdown area speckle structure so that energy of separate speckle increases breakdown threshold.

7. A method in accordance with claim 1 wherein the formation of a laser-induced spark arrangement reproduces 2D or 3D pictures, the space resolution of which is determined by the number of sparks and the image gradation is reproduced by the brightness modulation of separated sparks.

8. A method in accordance with claim 1 wherein the areas where laser energy increases breakdown threshold are created by either focusing laser radiation or intersection of several beams.

9. A method in accordance with claim 1 wherein the areas, where laser energy increases breakdown threshold are created by self-focusing of the laser radiation so that the control for positions and shapes of self-focusing areas is provided by the control of space structure of the laser radiation, its energy and pulse duration.

10. A method in accordance with claim 1 wherein the fireworks are created inside inflated balloons having transparent covering so that firework sparks have special brightness and color characteristics due to the special gases and special inclusions contained inside the balloons and due to the characteristics of the transparent covering.

11. A method in accordance with claim 1 wherein the laser radiation used for generation of fireworks is pulsed

12. A method in accordance with claim 1 wherein the laser radiation used for generation of the fireworks is invisible with naked eye that is achieved by using the corresponding wave-length or pulse duration.

13. A method for creation of a laser show, comprising:
creation of the lightweight inflated balloons the surfaces of which have the characteristics needed for the generation of the desirable laser-material interaction effects;
infilling the said balloons of the additional lightweight objects which are used during laser show and launching these balloons inside the scene area of the show;
generation and formation of visible and invisible laser beams for which a surrounding gaseous medium is transparent and which are able to produce desirable interaction with the said balloons;
generation of laser-induced breakdowns at the predetermined areas of the said scene areas;
control of the laser beam energy for generation of desirable interaction of the laser radiation with a surrounding gaseous medium and the elements of the scene area for the purpose of generating the specific visual effects.

14. A method in accordance with claim 13 wherein laser radiation directed from one balloon interacts with material of another balloon for creating desirable visual effects.

15. A method in accordance with claim 14 wherein the illusion of effects of interaction between several balloons is created by using laser radiation generated by land-based laser.

16. A method in accordance with claim 13 wherein the inflated balloons have shapes desirable for the show and can have special elements on their surfaces for reflecting and focusing laser radiation.

17. A method in accordance with claim 13 wherein desirable show effects are created by the combination of different physical phenomenon accompanying the laser-material interaction.

18. A method in accordance with claim 13 wherein the surfaces of the inflated balloons or arrangements of the light parts appeared after destruction of a balloon can be used as big screens for the projection of light pictures accompanying the laser show.

19. A method in accordance with claim 13 wherein an interior of an inflated balloon is a show field and small inflated parts contained inside the balloon are subjects of laser-material interaction for the production of the desirable show effects.

20. A system for creation of fireworks and laser show, comprising:
system for show information gathering;
system for determination of inflated balloon characteristics;
system for determination of parameters of laser radiation producing desirable laser-material interaction effects;
system for creation of inflated balloons;
system for launching inflated balloons at the show field;
system for measurement of the balloons positions;
system for generation of the laser radiation;
system for creation breakdown areas at the pre-set positions;
system for controlling laser radiation during laser show.
